(19) United States
(12) Patent Application Publication
(10) Pub. No.: US 2018/0142377 A1
(43) Pub. Date: May 24, 2018

(54) Medical Instrument Made of Monocrystalline Shape Memory Alloys and Manufacturing Methods

(71) Applicants: Yong Gao, Broken Arrow, OK (US); Dan Ammon, Tulsa, OK (US); Geoffrey Kamau NDUNGU, Tulsa, OK (US)

(72) Inventors: Yong Gao, Broken Arrow, OK (US); Dan Ammon, Tulsa, OK (US); Geoffrey Kamau NDUNGU, Tulsa, OK (US)

(73) Assignee: DENTSPLY International Inc., York, PA (US)

(21) Appl. No.: 15/357,519

(22) Filed: Nov. 21, 2016

(51) Int. Cl. C30B 29/52; C22C 19/03; C22C 9/01; C22C 38/08; C22C 1/02; C30B 15/34; C30B 33/02; C30B 33/10; A61C 5/42; A61C 7/20

(52) U.S. Cl. CPC C30B 29/52; C22C 19/03; C22C 9/01; C22C 38/08; C22C 1/02; A61C 2201/007; C30B 33/02; C30B 33/10; A61C 5/42; A61C 7/20; C30B 15/34

(57) ABSTRACT

A medical instrument comprising a mono-crystalline shape memory alloy and a method for forming thereof.

### RELATED APPLICATIONS

This is a continuation of U.S. patent application Ser. No. 13/837,704, filed on Mar. 15, 2013, which claims the benefit of and priority to U.S. Provisional Patent Application Ser. No. 61/611,073, filed on Mar. 15, 2012, which are herein incorporated by reference for all purposes.

### TECHNICAL FIELD

The present invention is directed to medical instruments such as a medical wire and/or a medical instrument made of mono-crystalline shape memory alloys (or called single crystal SMA); more particularly, one or more components of a dental instrument such as an orthodontic archwire and/or an endodontic instrument employing mono-crystalline shape memory alloys and associated manufacturing methods.

### BACKGROUND OF THE PRESENT INVENTION

Orthodontic Archwires

Orthodontic archwires are used in dental braces during orthodontic treatment to align and reposition teeth so as to achieve optimum formation of the maxillary (upper) and mandibular (lower) dental arches as well as to improve dental health. As shown in FIG. 1, orthodontic archwires are typically engaged in the bracket slots (brackets are attached to teeth) for moving teeth to pre-determined positions based on the orthodontic treatment plan. In the early 1980s, the introduction of NiTi SMA wires has revolutionized orthodontic treatment by improving the efficiency, quality, and patients' experience and satisfaction. By using NiTi archwire, the orthodontic treatment time has been significantly reduced compared to other archwires made of Au—Ni or stainless steels. As shown in FIG. 2, archwires made of stainless steel would have very high initial pulling force; however, due to its high elastic limit, that force would decrease rapidly within a short period time (e.g., less than 10 days) after small movement of the teeth. Therefore, the effective strain range corresponding to the optimal active pulling force range is very limited for archwires made of alloys with high elastic modulus such as stainless steels. Thus, patients are required for more frequent visit for further adjustment or replacement with new archwires. With relatively low elastic modulus and superelasticity (superelasticity occurs when the stress exceeds the elastic limit for stress-induced martensitic transformation; a constant plateau stress up to 8% strain), the effective strain range of polycrystalline SMA is much larger than that of stainless steels. For mono-crystalline SMA, the constant plateau force may be effective up to 20% in strain, which results in even larger range for effective strain corresponding to the same optimal force range than polycrystalline SMA. In addition, the transition temperatures of mono-crystalline SMA can be easily and more precisely controlled than polycrystalline SMA because better homogeneity of chemical composition and less crystalline defects during manufacturing.

It is appreciated that the advantages of orthodontic archwire made of single crystal SMA may be 1) large effective strain range due to its recoverable distortion up to about 20% (e.g., about 10 to about 15%); 2) constant tensile force (upper plateau stress) over a large strain due to its superior superelasticity; and/or 3) more precise transition temperatures.

Endodontic Instruments

In endodontic treatment, one important procedure is to use endodontic instrument for cleaning and shaping a root canal to remove tissue and dentine debris prior to filling the canal with obturation materials. As shown in FIG. 3, a typical endodontic file may include a file handle and tapered and spiral cutting flutes. Endodontic files are typically made of stainless steels (e.g., hand file only) or polycrystalline SMA (such as polycrystalline NiTi SMA). The low Young's modulus and superelasticity of endodontic instruments made of SMA enables the continuous rotary or reciprocating preparation of root canals. Even though the flexibility of NiTi SMA based endodontic files has been improved significantly compared to stainless steel, procedural errors such as ledging, transportation, or even perforation may still occur sometimes, especially for cases when files with larger size or greater taper negotiate root canals with severe curvatures.

An attempt to solve this deficiency may include endodontic instruments made of mono-crystalline SMA with large recoverable distortion (up to about 20% (e.g., about 5 to about 15, preferably about 10 to about 15% in strain), which may further improve the flexibility of SMA endodontic files and minimize the deviation from the original canal curvature during root canal instrumentation. As shown in FIG. 4, a “typical” superelastic stress-strain curve in tensile test is provided, wherein, the end of loading plateau is reached at about 6% strain for polycrystalline SMA. The stress will increase drastically with strain after that (typically 6% for polycrystalline SMA), which means greater stress or pressure of endodontic file negotiating or shaping inside root canal or higher possibility of forming ledges or transportation. However, with larger recoverable strain (typically larger than 10%), the stress level on the endodontic file made of mono-crystalline SMA can still remain relatively low at the plateau level (i.e., for the strain between 6% and 8% as shown in FIG. 4). Thus, the endodontic file made of mono-crystalline SMA could reduce the possibility of straightening the original canal shape during instrumentation and minimize the development of ledges, apical zipping, canal transportation, and perforations.

It is appreciated that advantages of endodontic files made of single crystal SMA may include, but are not limited to: 1) large recoverable distortion (up to ˜20%); 2) improved flexibility; (also crystallographic orientation-dependent flexibility); 3) superior crystalline perfection and minor internal defects compared to polycrystalline counterparts; and/or 4) new manufacturing methods that could simplify manufacturing process or reduce the waste of raw materials by using advanced crystal growth technologies.

### SUMMARY OF THE INVENTION

The present invention seeks to improve upon prior medical instruments by providing an improved process for manufacturing medical instruments. In one aspect, the present invention provides a medical instrument comprising a mono-crystalline shape memory alloy.

In another aspect, the present invention contemplates a method for forming a mono-crystalline shape memory alloy medical instrument comprising the steps of providing a mono-crystalline shape memory alloy; and shaping the mono-crystalline shape memory alloy to form a medical instrument.

In another aspect, the present invention contemplates a method for forming a mono-crystalline shape memory alloy medical instrument, comprising the steps of: providing a melt of a shape memory alloy; introducing at least one crystal seed to the melt; growing mono-crystalline articles; withdrawing the at least one crystal seed and the mono-crystalline articles at rate less than the rate of mono-crystalline growth; and shaping the withdrawn mono-crystalline growth to form a medical instrument.

In yet another aspect, any of the aspects of the present invention may be further characterized by one or any combination of the following features: the medical instrument is a dental instrument; the mono-crystalline shape memory alloy is selected from the group consisting of a NiTi-based shape memory alloy, a Copper-based shape memory alloy, and a Iron-based shape memory alloy; the NiTi-based shape memory alloy is of the formula NiTiX such that X is selected from the group consisting of Fe, Cu, Cr, Nb, and Co; the Copper-based shape memory alloy is selected from the group consisting of CuAlBe, CuAlFe, CuAlZn, CuAlNi, and CuAlZnMn; the Iron-based shape memory alloy is selected from the group consisting of FeNiAl, FeNiCo, FeMnSiCrNi, and FeNiCoAlTaB; the medical instrument is an endodontic file; the medical instrument is an orthodontic arch wire; the mono-crystalline shape memory alloy is selected from the group consisting of a NiTi-based shape memory alloy, a Copper-based shape memory alloy, and an Iron-based shape memory alloy; the shaping step the mono-crystalline shape memory alloy forms a wire; the method further comprises the step of grinding, heat treating, twisting, acid etching, or any combination thereof the mono-crystalline shape memory alloy to form the medical instrument; the method further comprises the step of heat treating the mono-crystalline shape memory medical instrument to form a mono-crystalline non-shape memory medical instrument; the shaping step includes withdrawing the mono-crystalline growth through a die, the die having rotatable elements to achieve a taper, a flute pattern, a helical angle, or any combination thereof; the mono-crystalline growth is pulled through the die; the cross-section of the die throughhole from which the mono-crystalline growth is pulled through is generally triangular; the die includes at least one movable portion to define a throughhole for shaping the mono-crystalline growth being withdrawn therethrough; the die includes at least three movable portions to define a throughhole for shaping the mono-crystalline growth being withdrawn therethrough; the die includes between one and five movable portions to define a throughhole for shaping the mono-crystalline growth being withdrawn therethrough; the method further comprises the step of controlling the temperature of the melt, the rate of withdrawing the mono-crystalline growth, or a combination of both; the method further comprising the steps of: providing a container for receiving the melt; and feeding the melt to the container; the introducing step, the mono-crystalline growth is initially nucleated by a single crystal seed and then continues in a self-seeding manner; or any combination thereof.

It should be appreciated that the above referenced aspects and examples are non-limiting as others exist with the present invention, as shown and described herein. For example, any of the above mentioned aspects or features of the invention may be combined to form other unique configurations, as described herein, demonstrated in the drawings, or otherwise.

### BRIEF DESCRIPTION OF THE DRAWINGS

FIG. 1 is a bottom view of a typical orthodontic archwire that is ligated to orthodontic brackets mounted to the teeth;

FIG. 2 is a schematic illustration of stress-strain curve (with loading and unloading) of orthodontic archwires made of three different materials: stainless steel (solid line), conventional polycrystalline SMA (dashed line), and mono-crystalline SMA (dash-dot line). For stainless steel, the effective strain (ε₁) corresponding to the optimal force range is very limited; for conventional polycrystalline SMA, the effective strain range ε₂ is much larger than that of stainless steel; for mono-crystalline SMA, the effective strain range ε₃ is the largest compared to both stainless steel and conventional polycrystalline SMA;

FIG. 3 is a top view of endodontic instrument having a first portion with file handle and a second portion with tapered and spiral cutting flutes;

FIG. 4 is another schematic illustration of stress-strain curves of polycrystalline SMA (solid line) and mono-crystalline SMA (dashed line) used in endodontic instruments. For a given large strain (ε>6%), the stress level of endodontic files made of polycrystalline SMA (σ_{poly}) may be significantly higher than that of mono-crystalline SMA (σₘₒₙₒ);

FIG. 5 is a schematic illustration of an exemplary crystal grow apparatus, which may include a Crystal 1; a Shaper or Die 2; a Melt 3; and a Crucible 4; and

FIGS. 6a-6c is a schematic illustration of exemplary dies having different shapes or designs used in single crystal growth. For example, FIG. 6a illustrates a rectangular shape die; FIG. 6b illustrates a circular shape die; and FIG. 6c illustrates a triangular shape die. Die shown in (C) or with similar mechanism may be used for direct growth or manufacturing of medical instrument such as endodontic file with tapered spiral cutting flutes. For example, the triangular cross-sectional shape and configuration may be controlled by rotating the three movable elements (indicated by those three arrows) within the die. By precisely controlling the relative speeds between the crystal pulling and die/element rotation, desired configuration (taper, flute pattern, helical angle) of endodontic instrument may be achieved during the crystal growth process.

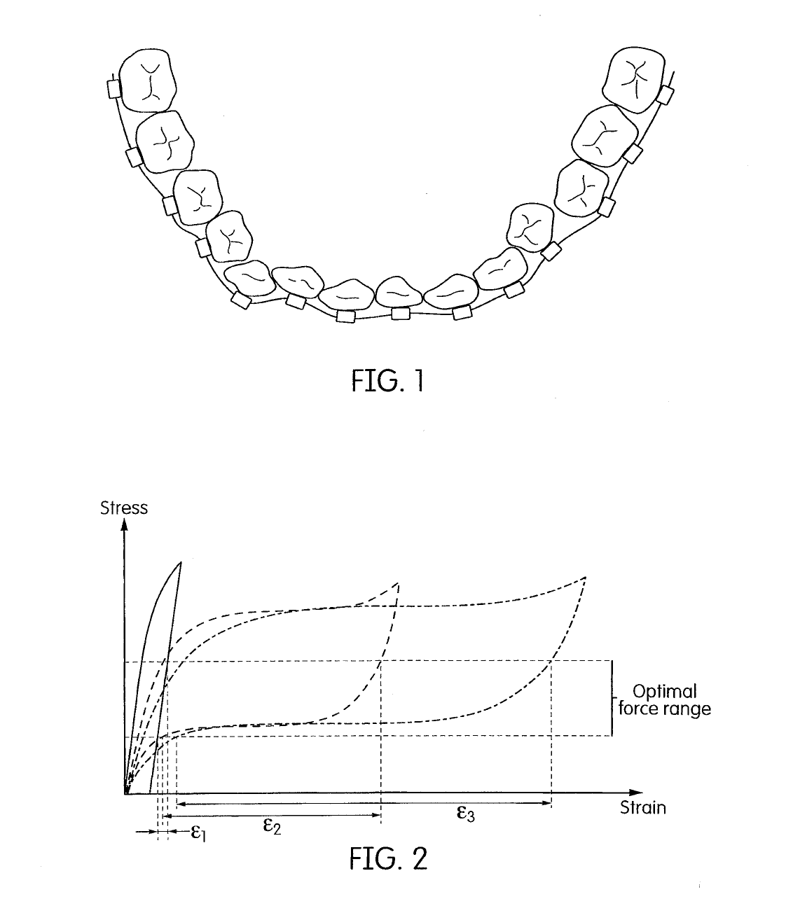

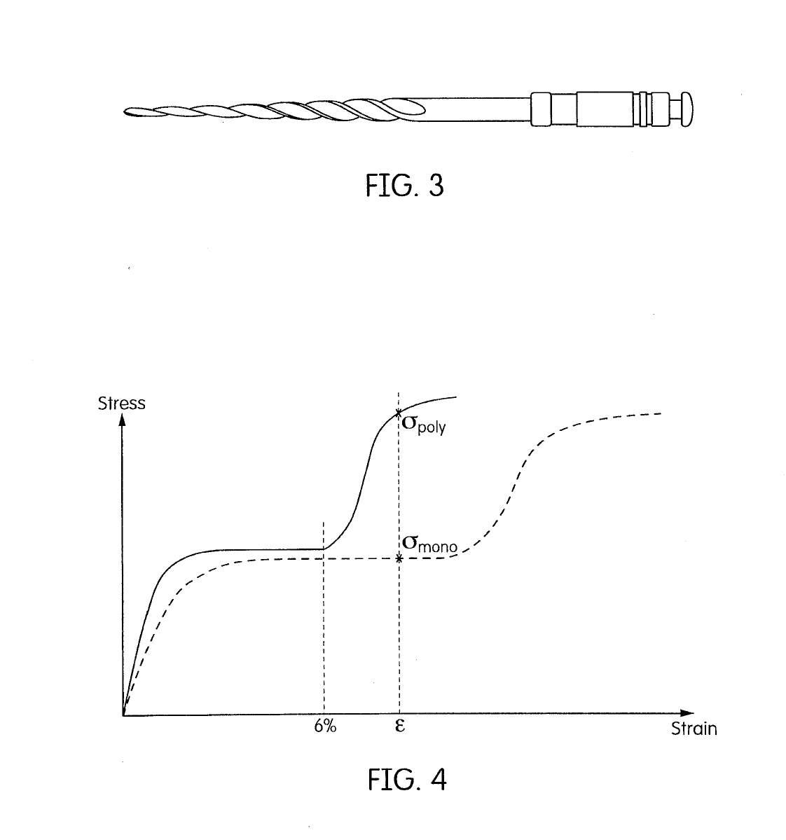

### DETAILED DESCRIPTION

The present invention contemplates a medical instrument formed of a mono-crystalline material. Desirably, the medical instrument is a dental instrument such as an orthodontic wire (e.g., archwire), an endodontic file, or otherwise. However, other medical instruments are also appreciated. The mono-crystalline material may include a shape memory alloy. Generally, the shape memory alloys include, but are not limited to, NiTi, NiTi-based SMA (NiTiX, X: Fe, Cu, Cr, Nb, Co), Copper-based SMA (CuAlBe, CuAlFe, CuAlZn, CuAlNi, CuAlZnMn), Iron-based SMA (FeNiAl, FeNiCo, FeMnSiCrNi, or FeNiCoAlTaB). For example, the mono-crystalline shape memory alloy may be selected from the group consisting of a NiTi-based shape memory alloy, a Copper-based shape memory alloy, and an Iron-based shape memory alloy. Examples of NiTi-based shape memory alloy may include, but are not limited to, the formula NiTiX such that X is selected from the group consisting of Fe, Cu, Cr, Nb, and Co. Examples of Copper-based shape memory alloy may be selected from the group consisting of CuAlBe, CuAlFe, CuAlZn, CuAlNi, and CuAlZnMn. Examples of Iron-based shape memory alloy may be selected from the group consisting of FeNiAl, FeNiCo, FeMnSiCrNi, and FeNiCoAlTaB.

Optionally, the medical instrument may further include a coating. The coating may be present having a thickness ranging from about 0.25 to about 7.0, and preferably from about 0.5 to about 5.0 (e.g., about 1.0 to about 4.0) microns. The coating may include a Friction (fretting) Coefficient ranging from about 0.025 to about 0.75, and preferably from about 0.2 to about 0.6 (e.g., about 0.3 to about 0.5). The coating may include a hardness of at least about 500, preferably at least about 1000, and most preferably at least about 2000 HV (Vickers Pyramid Number). Furthermore, it is appreciated that the coating may include a hardness of less than about 5000, preferably less than about 4000, and most preferably less than about 3000 HV. For example, the coating may include a harness ranging from about 500 to about 5000, preferably from about 1000 to about 4000, and preferably from about 2000 to about 3000 HV.

The coating may include a maximum working temperature of at least about 50, preferably at least 200, and most preferably at least 500° C. Furthermore, it is appreciated that the coating may include a maximum working temperature of less than about 2000, preferably less than about 1700, and most preferably less than 1200° C. For example, the coating may include a maximum working temperature ranging from about 50 to about 2000, preferably from about 200 to about 1700, and preferably from about 500 to about 1200° C. Examples of the coating include, but are not limited to, parylene (e.g., parylene N, parylene C, parylene D, and parylene HT), TiAlCN (Titanium Aluminum Carbonitride), TiN (Titanium Nitride), TiCN (Titanium Carbonitride), ZrN (Zirconium Nitride), CrN (Chromium Nitride), TiAlN (Titanium Aluminum Nitride), AlTiN (Aluminum Titanium Nitride), AlTiSiN (Aluminum Titanium Silicon Nitride), AlTiCrN (Aluminum Titanium Chromium Nitride), Quantum (Titanium Nitride Alloy), X-LC (Molybdenum Disulfide), DLC (Diamond Like Carbon), and otherwise and any combination thereof.

Method for Manufacturing Medical Instruments

Generally, the method for forming a mono-crystalline shape memory alloy medical instrument may include the steps of providing a mono-crystalline shape memory alloy and shaping the mono-crystalline shape memory alloy to form a medical instrument. Crystal growing is a technological process of crystallization carried out to obtain single crystals or films of different materials. Desirably, the mono-crystalline shape memory allow may be formed by the Czokhralski method, the Float-Zone Crystal Growth method, the Stepanov method, or otherwise.

In the Czokhralski method, the raw material may be charged into a refractory crucible and is heated until it all generally melts down. Then a seed crystal shaped as a thin rod of a few mm in diameter is mounted onto a seed crystal holder and is dipped into the melt. All through the process the seed crystal holder is being cooled. The column of the melt which connects the grown crystal with the melt is maintained by surface tension force and this column forms a meniscus between the surface of the melt and the growing crystal. The solid-melt interface, or crystallization front, gets over the surfaces of the melt. The temperature of the melt and the conditions of the abstraction of heat from the seed crystal determine how high the crystallization front gets. When the end of the seed partially melts the seed is pulled out of the melt together with the crystallized material. At the same time the crystal is being rotated. It helps to keep the melt blended and to maintain the same temperature at the crystallization front. As a result of heat abstraction an oriented single crystal starts growing on the seed. The diameter of the crystal may be controlled by adjusting the speed of growth and the temperature of the melt. The pulling technology may vary depending on the type of material crystallized and the desired result. Crystals may be pulled in vacuum and in inert gas under different pressure, with or without a container.

In Float-Zone Crystal Growth method, the raw material (e.g., a polycrystalline material) may be passed through a heating element such as an RF heating coil or otherwise, which creates a localized molten zone from which the crystal ingot grows. A seed crystal is used at one end in order to start the growth. The whole process may be carried out in an evacuated chamber or in an inert gas purge. It is believed that since the melt never comes into contact with anything but vacuum (or inert gases), there is no incorporation of impurities. As such, the molten zone may carry the impurities away with it and hence reduces impurity concentration (most impurities are more soluble in the melt than the crystal).

In the Stepanov (Edge-Defined Film Fed Growth, EFG) method, crystals may be grown from the melt film formed on top of a capillary die. The melt rises from the crystallization front within the capillary channel. The growth speed is 1 to 4 cm/hour in inert medium (argon). The method makes it possible to grow crystals of complicated shape. Desirably, with the help of an automated computer system, the weight, shape and quality of the crystals may be constantly or variably controlled during the growth process. Crystals grown by this method may have different crystallographic orientations (A, C, random).

The shaping step may include forming the mono-crystalline shape memory alloy into a wire. Other examples of the shaping step may include, but are not limited to, withdrawing the mono-crystalline growth through a die (e.g., shaper), the die having rotatable elements to achieve a taper, a flute pattern, a helical angle, or any combination thereof, pulling the mono-crystalline growth through the die, the die includes at least one movable portion to define a throughhole for shaping the mono-crystalline growth being withdrawn therethrough, the cross-section of the die throughhole from which the mono-crystalline growth is pulled through is generally triangular, rectangular, square, or circular; the die includes at least three movable portions to define a throughhole for shaping the mono-crystalline growth being withdrawn therethrough, and any combination thereof.

The method may further included one or more of the following steps grinding, heat treating, twisting, acid etching, or otherwise and any combination thereof the mono-crystalline shape memory alloy to form the medical instrument. In one specific embodiment, the method may include the step of controlling the temperature of the melt, the rate of withdrawing the mono-crystalline growth, or a combination of both.

In another embodiment of the present invention, the method for forming a mono-crystalline shape memory alloy medical instrument may include the steps of providing a melt of a shape memory alloy; introducing at least one crystal seed to the melt; growing mono-crystalline articles; withdrawing the at least one crystal seed and the mono-crystalline articles at rate less than the rate of mono-crystalline growth; and shaping the withdrawn mono-crystalline growth to form a medical instrument. Desirably, in the introducing step, the mono-crystalline growth may be initially nucleated by a single crystal seed and then continues in a self-seeding manner. Optionally, the method may further include the steps of providing a container for receiving the melt; and/or feeding the melt to the container.

Manufacturing Methods for Orthodontic Archwires:

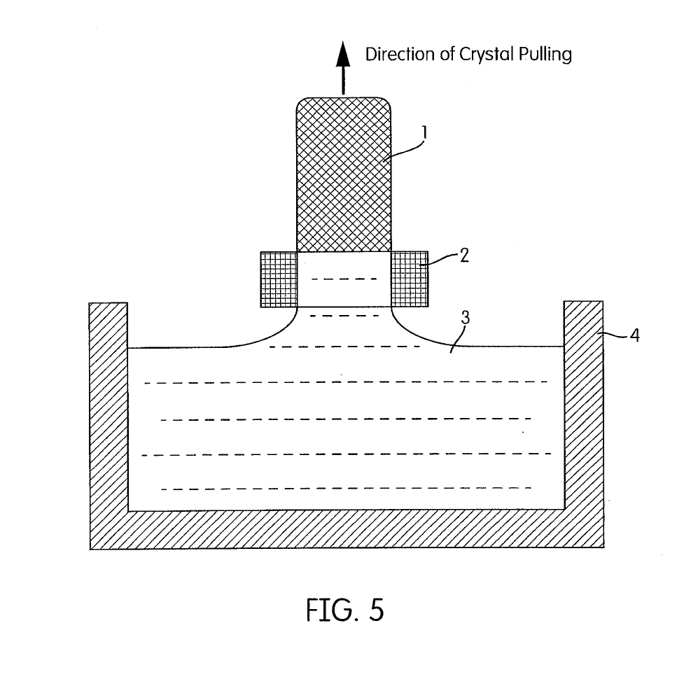

Shaped single crystal with desired cross-sectional shape (such as wire with circular cross-sectional shape, or ribbon with rectangular cross-sectional shape) may be manufactured in a crystal-growth apparatus (similar to Stepanov's shaped crystal growth method) such as in FIG. 5. Essentially, a liquid melt column with pre-determined crystal orientation and cross-sectional shape (which may be determined by the shape of a die or shaper on the top surface of the liquid melt) is converted into a single crystal solid by properly controlling the growth rate and temperature profile.

The mechanical properties of orthodontic archwires made of the grown single crystal may be further modified through post heat treatments.

Manufacturing Methods for Endodontic Instruments:

Method 1: SMA single crystal wire may be made by converting polycrystalline SMA with same chemical composition using single crystal growth methods, such as Czochralski (Cz) or Float Zone (FZ). Generally, a seed crystal is dipped into the liquid melt with a surface temperature slightly above the melting temperature and a single crystal SMA is pulled out of it. The wire diameter (generally less than 2 mm, though greater than 2 mm is contemplated) may be controlled by the seed orientation, pulling rate and temperature profile. The mechanical properties of single crystal SMA may be controlled by the alloy composition, pulling rate, and cooling rate. The single crystal SMA wire may be further ground to make endodontic files (similar to the conventional manufacturing method using centerless grinding and disc grinding) or by other manufacturing techniques (such as twisting or laser-cutting). In addition, a relatively harder & stronger polycrystalline thin film may be formed at surface in a controlled manner during grinding process. A harder polycrystalline surface layer could improve cutting efficiency and wear resistance. Alternatively, surface coating with higher hardness would be applied to improve the wear resistance or cutting efficiency as discussed herein.

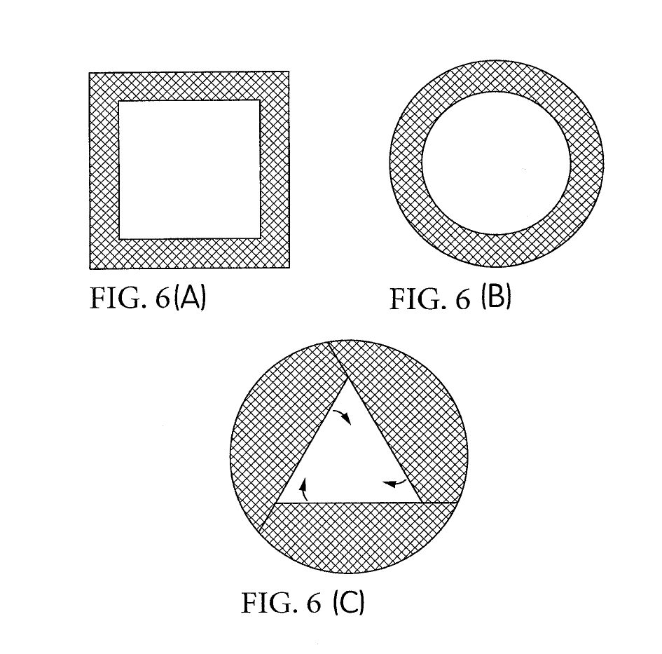

Method 2: Shaped single crystal with a desired cross-sectional shape may be formed in a crystal-growth apparatus (similar to Stepanov's shaped crystal growth method). Generally, a liquid melt column with pre-determined crystal orientation and cross-sectional shape (which is determined by the shape of a die or shaper on the top surface of the liquid melt) is converted into a single crystal solid by properly controlling the growth rate and temperature profile. Finished or semi-finished endodontic file with more complex cross-sectional shape (other than circular, such as square and triangle) may be directly made in a special crystal-pulling apparatus equipped with multiple controls such as seed orientation, growth orientation, pulling rate, cooling media and rate. By controlling the crystallographic orientation of the starting growth seed as well as the tension and direction in the crystal pulling process, endodontic files with a tapered profile or more complex cross-sectional geometry with more aggressive cutting edges may be manufactured. The “Variable Shaping Technique” (VST) enables to grow complex mono-crystal by varying the dimension and configuration of the cross-section such as shown in FIGS. 6a-6c. It doing so, it may be possible to make a gradual transition from one configuration of the cross-section to another during a single crystal growth process. Ideally, the endodontic file with tapered spiral cutting flutes may be grown directly from liquid melt by using a modified “Variable Shaping Technique” by controlling the solidification rate, the variable cross-sectional area as well as the orientation of the cross-section (by varying the pulling profile cross-sectional dimension and orientation simultaneously by controlling the displacement of movable die elements) such as shown in FIG. 6c.

The mechanical properties of endodontic files made of the grown single crystals may be further modified through post heat treatments.

The present invention contemplates improvements in medical instruments including improved resistance to cyclic fatigue and/or resistance to fracture by twisting as shown in a cyclic fatigue test, a torque test, and a flexibility test. The cyclic fatigue test measures the medical instrument's resistance to fatigue and includes a test stand having a grooved mandrel positioned adjacent to a deflection block having an arcuate surface concentric to and spaced from the perimeter of mandrel. The mandrel has on the peripheral surface a shallow depth groove. Supported near the deflection block is a rotating instrument holder that has a chuck by which the proximal portion of the shaft of an endodontic instrument can be secured. Positioned adjacent deflection block is a nozzle that is employed to eject a temperature control medium, such as compressed air onto endodontic instrument. In these tests, the endodontic instrument was rotated, that is, spinning counterclockwise at 500 rpm. Rotation of endodontic instrument was continued until it broke as a result of bending fatigue. The flexibility test measures the medical instrument's stiffness as described in ISO 3630-1:2008, Dentistry—Root-canal instrument—Part I: General requirements and test methods). A torque test measures the medical instrument's resistance to fracture by twisting and angular deflection as described in ISO 3630-1:2008, Dentistry—Root-canal instrument—Part I: General requirements and test methods).

In one specific example, rotary endodontic instruments were prepared according to the present invention and tested relative to known martensitic NiTi rotary endodontic instruments. The similarly shaped and sized rotary endodontic instruments included 25 mm endodontic files having a 4% taper with variable helical angle flutes and a triangular cross-section. Furthermore, Sample A included the martensitic NiTi rotary endodontic files while Samples B and C included copper-aluminum based rotary endodontic files according to the present invention. The results are shown in Table 1.

TABLE 1

| | Sample A | | Sample B | | Sample C | |
|---|---|---|---|---|---|---|
| Test | Avg | Std. Dev | Avg | Std. Dev | Avg | Std. Dev |
| Cyclical Fatigue | 3.597 | 0.445 | 0.817 | 0.306 | 19.205 | 3.021 |
| (min.) | | | | | | |
| Torque | | | | | | |
| Peak Torque | 1.14 | 0.12259 | 0.67 | 0.178 | 0.85 | 0.372 |
| (in. oz.) | | | | | | |
| Degree of Rotation | 346 | 25.634 | 204 | 24.332 | 92 | 25.188 |
| Flexibility | | | | | | |
| Peak Torque | 0.69 | 0.021 | 0.59 | 0.032 | 0.27 | 0.048 |
| (in. oz.) | | | | | | |

It will be further appreciated that functions or structures of a plurality of components or steps may be combined into a single component or step, or the functions or structures of one-step or component may be split among plural steps or components. The present invention contemplates all of these combinations. Dimensions and geometries of the various structures depicted herein are not intended to be restrictive of the invention, and other dimensions or geometries are possible. References to directions are intended to clarify the description and do not in any way limit the scope of the invention. In other embodiments, the reference directions may be other than are shown, disclosed, or arranged differently. Also, it is to be understood that the phraseology and terminology used herein is for the purpose of description and should not be regarded as limiting. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. A medical instrument comprising a mono-crystalline shape memory alloy prepared by the process comprising the steps of:
providing a melt of a shape memory alloy;
introducing at least one crystal seed to the melt;
growing mono-crystalline articles;
withdrawing the at least one crystal seed and the mono-crystalline articles at rate less than the rate of mono-crystalline growth; and
shaping the withdrawn mono-crystalline growth to form a medical instrument.

2. The medical instrument of claim 1, wherein the medical instrument is a dental instrument.

3. The medical instrument of claim 1, wherein the mono-crystalline shape memory alloy is selected from the group consisting of a NiTi-based shape memory alloy, a Copper-based shape memory alloy, and an Iron-based shape memory alloy.

4. The medical instrument of claim 3, wherein NiTi-based shape memory alloy is of the formula NiTiX such that X is selected from the group consisting of Fe, Cu, Cr, Nb, and Co.

5. The medical instrument of claim 3, wherein Copper-based shape memory alloy is selected from the group consisting of CuAlBe, CuAlFe, CuAlZn, CuAlNi, and CuAlZnMn.

6. The medical instrument of claim 3, wherein Iron-based shape memory alloy is selected from the group consisting of FeNiAl, FeNiCo, FeMnSiCrNi, and FeNiCoAlTaB.

7. The medical instrument of claim 3, wherein the medical instrument is an endodontic file or an orthodontic arch wire.

8. A method for forming a mono-crystalline shape memory alloy medical instrument, comprising the steps of:
providing a mono-crystalline shape memory alloy; and
(ii) shaping the mono-crystalline shape memory alloy to form a medical instrument.

9. The method of claim 8, wherein the medical instrument is an endodontic file or orthodontic arch wire.

10. The method according to claim 8, wherein the mono-crystalline shape memory alloy is selected from the group consisting of a NiTi-based shape memory alloy, a Copper-based shape memory alloy, and an Iron-based shape memory alloy.

11. The method according to claim 10, wherein the NiTi-based shape memory alloy is of the formula NiTiX such that X is selected from the group consisting of Fe, Cu, Cr, Nb, and Co.

12. The method according to claim 10, wherein the Copper-based shape memory alloy is selected from the group consisting of CuAlBe, CuAlFe, CuAlZn, CuAlNi, and CuAlZnMn.

13. The method according to claim 10, wherein the Iron-based shape memory alloy is selected from the group consisting of FeNiAl, FeNiCo, FeMnSiCrNi, and FeNiCoAlTaB.

14. The method according to claim 8, further comprising the step of grinding, heat treating, twisting, acid etching, or any combination thereof the mono-crystalline shape memory alloy to form the medical instrument.

15. A method for forming a mono-crystalline shape memory alloy medical instrument, comprising the steps of:
providing a melt of a shape memory alloy;
introducing at least one crystal seed to the melt;
growing mono-crystalline articles
withdrawing the at least one crystal seed and the mono-crystalline articles at rate less than the rate of mono-crystalline growth;
shaping the withdrawn mono-crystalline growth to form a medical instrument.

16. The method according to claim 15, wherein the mono-crystalline shape memory alloy is selected from the group consisting of a NiTi-based shape memory alloy, a Copper-based shape memory alloy, and an Iron-based shape memory alloy; wherein the NiTi-based shape memory alloy is of the formula NiTiX such that X is selected from the group consisting of Fe, Cu, Cr, Nb, and Co; wherein the Copper-based shape memory alloy is selected from the group consisting of CuAlBe, CuAlFe, CuAlZn, CuAlNi, and CuAlZnMn; and wherein the Iron-based shape memory alloy is selected from the group consisting of FeNiAl, FeNiCo, FeMnSiCrNi, and FeNiCoAlTaB.

17. The method according to claim 16, wherein the die includes at least one movable portion to define a throughhole for shaping the mono-crystalline growth being withdrawn therethrough

18. The method of claim 17, wherein the shaping step includes withdrawing the mono-crystalline growth through a die, the die having rotatable elements to achieve a taper, a flute pattern, a helical angle, or any combination thereof.

19. The method according to claim 16, wherein the introducing step, the mono-crystalline growth is initially nucleated by a single crystal seed and then continues in a self-seeding manner.

20. The method according to claim 19, further comprising the steps of:
providing a container for receiving the melt; and
feeding the melt to the container.
